(19) United States
(12) Patent Application Publication
(10) Pub. No.: US 2007/0241203 A1
(43) Pub. Date: Oct. 18, 2007

(54) Management of a thermostat's power consumption

(75) Inventors: Phillip Ryan Wagner, Baltimore, OH (US); John Gilman Chapman JR., Delaware, OH (US); Joseph P. Rao, Dublin, OH (US); Nicholas Ashworth, Dublin, OH (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Ranco Inc. of Delaware, Wilmington, DE (US)

(21) Appl. No.: 11/404,588

(22) Filed: Apr. 14, 2006

(51) Int. Cl. G05D 23/12

(52) U.S. Cl. 236/1 C

(57) ABSTRACT

An HVAC system comprises a programmable wireless thermostat and a remote receiver unit. The thermostat includes a user interface having one or more displays, user input devices, such as buttons, sliders, or a touch screen, and a backlight. The thermostat may include a proximity sensor, wherein the user interface is controlled based on a user's presence near the thermostat. A thermostat controller enters into a reduced energy consumption mode and switches the user interface to an idle state when the proximity sensor indicates a lack of user proximity for a predetermined duration. When the proximity sensor indicates user proximity, the controller exits the reduced energy consumption mode and switches the user interface to an active state. During the reduced energy consumption mode, the user interface may be concealed when the user interface is in a housing which is transparent when backlit but is opaque otherwise.

### FIELD OF THE INVENTION

The present invention relates to controlling the energy consuming state of an HVAC system thermostat and, more particularly, to managing the energy consuming state of a thermostat to reduce energy consumption when idle.

### BACKGROUND OF THE INVENTION

Heating, Ventilation and Air Conditioning (HVAC) systems maintain a stable and comfortable temperature environment inside a building interior. Typical HVAC systems include a furnace unit for heating the interior during a cold season, a fan for circulating the air, an air-conditioning unit for cooling the interior during a warm season, as well as a thermostat for controlling the furnace, the fan, and the air conditioning units in order to achieve the desired ambient temperature set by a user. The heating and cooling units are usually located in an area remote from a typical living environment. A likely location for a thermostat, on the other hand, is in a room where a typical user is most likely to interact with it and which closely approximates the environment where the temperature control is most desired. For example, one likely location for a thermostat is a living room. Hence, a typical thermostat installation requires dedicated wiring to be installed between a thermostat and the remote HVAC equipment it controls.

In a conventional thermostat installation, separate power and control wires are installed between a thermostat and the remote equipment. The power wires deliver the necessary line voltage that a thermostat requires to generate a relay control signal, which, in turn, allows the thermostat to control the remote equipment through the control wires. In a typical HVAC system, as many as five wires may be needed in order to install a conventional thermostat. In such an installation, two power wires may be used to supply a thermostat with a line voltage for generating the control signals, while three control wires may be necessary to communicate the control signals to the air conditioner, the furnace, and the furnace fan relays. This bundle of wires between the remote equipment and the thermostat often limits the possible locations of a conventional thermostat to areas accessible by runs of the wiring bundle.

However, there may be a need to relocate a thermostat to a different room in which a user is present more frequently than the room where the wiring terminals exist. In most situations, re-wiring existing buildings to relocate a thermostat is not cost-effective. Hence, a wireless thermostat may be a good solution to make a thermostat location independent from the location of power and control wiring.

A wireless thermostat installation usually includes a receiver located at the wiring terminals connected to the remote HVAC equipment, as well as a thermostat module which may either be portable or be permanently installed in a location which is not hardwired to the HVAC wiring terminals. In the case of a portable wireless thermostat, battery power is typically used to wirelessly communicate the control signals to the receiver and to operate the remaining thermostat functions. Similarly, if a wireless thermostat module is permanently installed in a location which does not have a power terminal nearby, it may operate on battery power. In such installations, therefore, battery consumption affects proper system operation and maintenance because battery power is required for the HVAC system to function.

Similarly, although power wiring is provided in a typical hardwired thermostat installation, such wiring is not always used to operate thermostat functions beyond relay control signaling. In a programmable thermostat, for example, the display screen, the backlight, the user input buttons, as well as the programmable controller, all require a power source. Hence, hardwired thermostats may also rely on batteries for proper system operation.

As can be seen, power consumption is a critical factor in proper operation of HVAC thermostats. Consequently, it is generally desired to minimize the power consumption in order to ensure uninterrupted HVAC system operation and reduce the system maintenance.

### BRIEF SUMMARY OF THE INVENTION

The invention provides a thermostat for controlling an operating state of an HVAC system. In one embodiment, the HVAC system comprises a programmable wireless thermostat and a remote receiver unit. The remote receiver unit is located where there exists AC voltage and control signal wiring connected to the furnace unit, the furnace fan, and the air conditioning unit. The remote receiver unit receives the wireless control signals from the thermostat and further communicates the received control signals to the remote HVAC equipment through the control signal wiring.

The thermostat includes a user interface having one or more displays, a plurality of user input devices, such as buttons, sliders, or a touch screen, and a backlight. The user interface is powered by an energy storage device, such as a battery, for example. In another embodiment, the user interface is powered by an energy source remote from the thermostat, such as a line voltage source located at the remote HVAC equipment. The line voltage source charges a battery or a storage capacitor in the thermostat.

In one embodiment, the thermostat includes a proximity sensor and the user interface is controlled based on a user's presence near the thermostat. The sensor may be a passive infrared (PIR) transducer, an ultrasonic transducer, an electromagnetic/electrostatic field transducer, a capacitive balanced field transducer, an acoustic/vibration transducer, an emissivity transducer, or a combination thereof.

The thermostat further includes a controller, which enters into a reduced energy consumption mode and switches the user interface to an idle state. This includes removing power from the backlight and the displays when the proximity sensor indicates a lack of user proximity for a predetermined duration. The reduced energy consumption mode provides an additional level of power conservation and extends the battery or storage capacitor charge needed to power the user interface. Consequently, when the proximity sensor indicates user proximity, the controller exits the reduced energy consumption mode and switches the user interface to an active state, which includes applying power to the backlight and the displays. In another embodiment, the intensity of the backlight is varied based on user proximity to the thermostat. While in the reduced energy consumption mode, the controller also reduces its clock rate, as well as reduces the sampling frequency of the output of a temperature sensor and of the user input devices.

In another embodiment, the user interface power control during the reduced energy consumption mode also allows for concealing the user interface when the user interface is in a housing which is transparent when backlit. The user interface is concealed by removing power from a backlight and from the displays, thereby making the user interface invisible. The power is reapplied upon user detection, which may be accomplished through a proximity sensor, or, alternately, through detecting a user input to the user interface. When the backlight power is reapplied, the user interface is revealed through the semi-transparent housing.

### BRIEF DESCRIPTION OF THE SEVERAL VIEWS OF THE DRAWING(S)

FIG. 1 is an exploded view of a building containing an HVAC system in keeping with the invention.

FIG. 2 is a perspective view of a thermostat for an HVAC system according to one embodiment of the invention showing a power consuming user interface and a proximity sensor, wherein user interface is in an idle state with the LCD and LED displays powered down;

FIG. 3 is a perspective view of the thermostat of FIG. 2, wherein the user interface is in an active state with the LCD and LED displays powered up;

FIG. 4 is a cross-sectional view of the thermostat of FIGS. 2-3 showing the location of the LCD and LED displays and of user input buttons;

FIG. 5 is a schematic diagram illustrating a wireless embodiment of the thermostat of FIGS. 2-4, and further depicting the electronics for switching the user interface between the active and idle states, as well as a light pipe apparatus for illuminating the user interface through one or more LCD backlight LEDs;

FIG. 5a is a schematic diagram illustrating a wired embodiment of the thermostat of FIGS. 2-4, wherein the thermostat is connected to the HVAC equipment through AC voltage and control signal wiring.

FIG. 5b is a flow diagram of a process executed by the controller of FIGS. 5 and 5a, wherein the controller switches the user interface to an idle state by entering the reduced energy consumption mode after the sensor indicates a lack of user proximity for a predetermined duration and exits a reduced energy consumption mode, which includes switching the user interface to an active state, after detecting a user in proximity of the thermostat.

FIG. 6 is a perspective view of a thermostat for an HVAC system according to another embodiment of the invention showing a power consuming user interface, a semi-transparent housing, and a proximity sensor, wherein the user interface is not visible while in the idle state when the sensor indicates a lack of user proximity;

FIG. 7 is a perspective view of the thermostat of FIG. 6, wherein the user interface is visible while in the active state when the sensor indicates user proximity;

FIGS. 8a and 8b are cross-sectional views of the thermostat of FIG. 6, showing an LCD display disposed behind the housing and alternative embodiments for the location of the LED display;

FIGS. 9a and 9b are cross-sectional views of the thermostat of FIG. 6, showing an LCD display disposed behind the housing and alternative embodiments for the location of the user input buttons; and

FIG. 10 is a flow diagram of another embodiment of a process executed by the controller of FIGS. 5 and 5a, wherein the controller switches the user interface to an idle state by entering the reduced energy consumption mode after a lack of user input for a predetermined duration and exits a reduced energy consumption mode, which includes switching the user interface to an active state, after detecting user input.

### DETAILED DESCRIPTION OF THE INVENTION

A thermostat for controlling an operating state of an HVAC system is disclosed. The thermostat includes a user interface having one or more displays, a plurality of user input devices, such as buttons, sliders, or a touch screen, and a backlight. The user interface may be powered by an energy storage device, such as a battery, for example. In another embodiment, the user interface is powered by an energy source remote from the thermostat. For example, a line voltage source can be located at the remote HVAC equipment and can charge a battery or a storage capacitor in the thermostat. In an embodiment where the thermostat includes a proximity sensor, the user interface is controlled based on a user's presence near the thermostat. In this case, the thermostat further includes a controller, or a switch, for switching the user interface to an idle state, which includes removing power from the backlight and the displays when the proximity sensor indicates a lack of user proximity for a predetermined duration. This provides an additional level of power conservation and allows the battery or storage capacitor to power the user interface for a longer period of time. Consequently, when the proximity sensor indicates user proximity, or presence, the controller switches the user interface to an active state, which includes applying power to the backlight and the displays. In another embodiment, the intensity of the backlight is varied based on user proximity to the thermostat. The user interface power control also allows for concealing the user interface when the user interface is in a housing which is transparent when backlit. The user interface is concealed by removing power from a backlight and from the displays, thereby making the user interface invisible. The power is reapplied upon user detection, which may be accomplished through a proximity sensor, or, alternately, through detecting a user input to the user interface. When the backlight power is reapplied, the user interface is revealed through the semi-transparent housing. In addition to conserving the operating power, this functionality increases the options for installation locations of a thermostat by making the user interface more aesthetically pleasing.

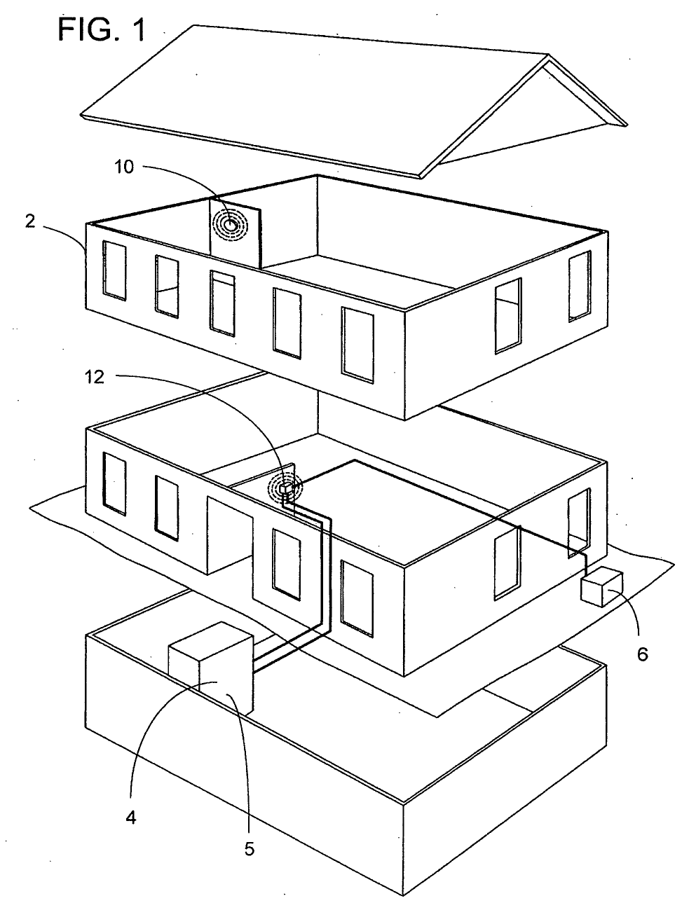

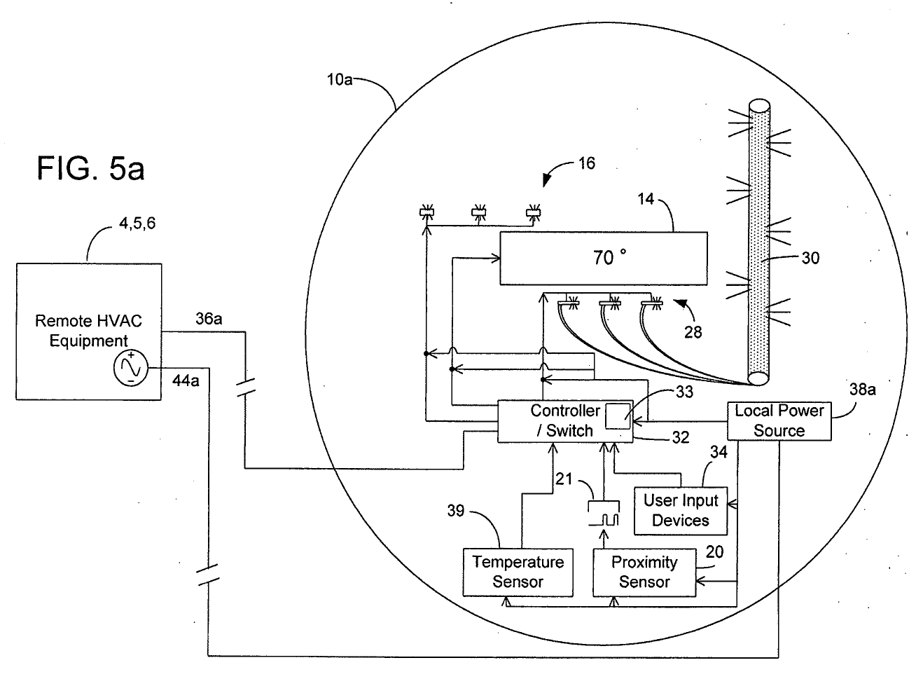

Turning now to the drawings, wherein like reference numbers refer to like elements, an HVAC system, including an embodiment of a thermostat according to the present invention, is disclosed in FIG. 1. The HVAC system of FIG. 1 is located in a building 2. To allow flexibility in thermostat installation options, this embodiment of an HVAC system comprises a programmable wireless thermostat 10, a remote receiver unit 12, and remote HVAC equipment, such as a furnace unit 4 and an air conditioning unit 6. The furnace unit 4 further includes a furnace fan 5 for circulating the air throughout the building 2. The remote receiver unit 12 is located where there exists AC voltage and control signal wiring connected to the furnace unit 4, the furnace fan 5, and the air conditioning unit 6. In one embodiment, the AC voltage wiring provides 24 VAC power from the remote HVAC equipment to the remote receiver unit 12 in order for the remote receiver unit 12 to communicate the control signals, received from the thermostat 10, which switch the relays in the furnace 4, the fan 5, and the air conditioning unit 6. The control signals, in turn, are initially transmitted by the wireless interface 36 (FIG. 5) of the thermostat 10. In the illustrated embodiment, the wireless interface 36 (FIG. 5) uses a ZigBee™ wireless protocol interface, however other embodiments may employ a different wireless protocol, such as IEEE 802.15.4, Bluetooth®, Wi-Fi®, or a similar short range, low power wireless protocol known in the art. When the wireless control signals are received by the remote receiver unit 12, the remote receiver unit 12 further communicates the control signals to the remote HVAC equipment through the control signal wiring.

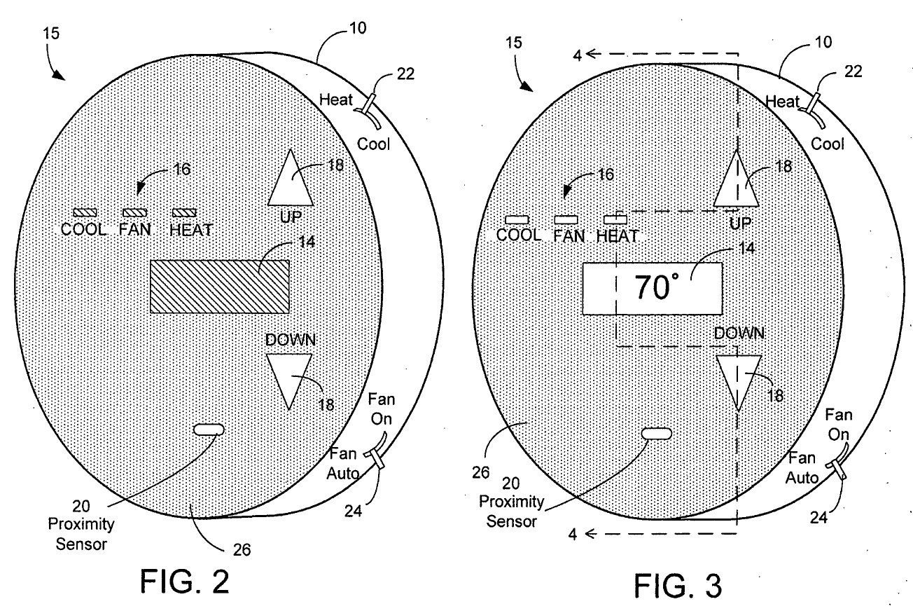

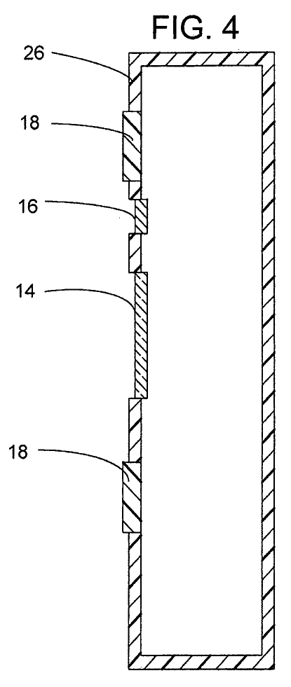

Referring to FIGS. 2 and 3, the wireless thermostat 10 includes a power consuming user interface 15 for setting and displaying the operating state of the HVAC system. The user interface 15 is disposed in a housing 26 and is comprised of conventional user interface technology. For example, to display the current and desired room temperatures, as well to display the system status and programming options, the user interface 15 comprises, in an embodiment, an LCD display 14 and, optionally, an LED display 16. In this embodiment, in order to provide an at-a-glance status of the HVAC system, the display of the currently active HVAC component is separated from the display of the room temperature and system programming options and reminders. This is accomplished by including an LED display 16, which includes a set of three status LEDs labeled “cool,” “fan,” and “heat,” that respectively turn on when the air conditioning unit 6, the fan 5, or the furnace unit 4 is activated.

Alternatively, the user interface 15 includes a single display which combines the temperature, system status, and programming settings information. Additionally, it should be noted that a person of skill in the art of HVAC thermostats will recognize that displays 14 and 16 may take on various forms such as an LCD display, an LED display, one or more status LEDs, an organic LED (OLED) display, an LCD touchpad display, or other forms known in the art.

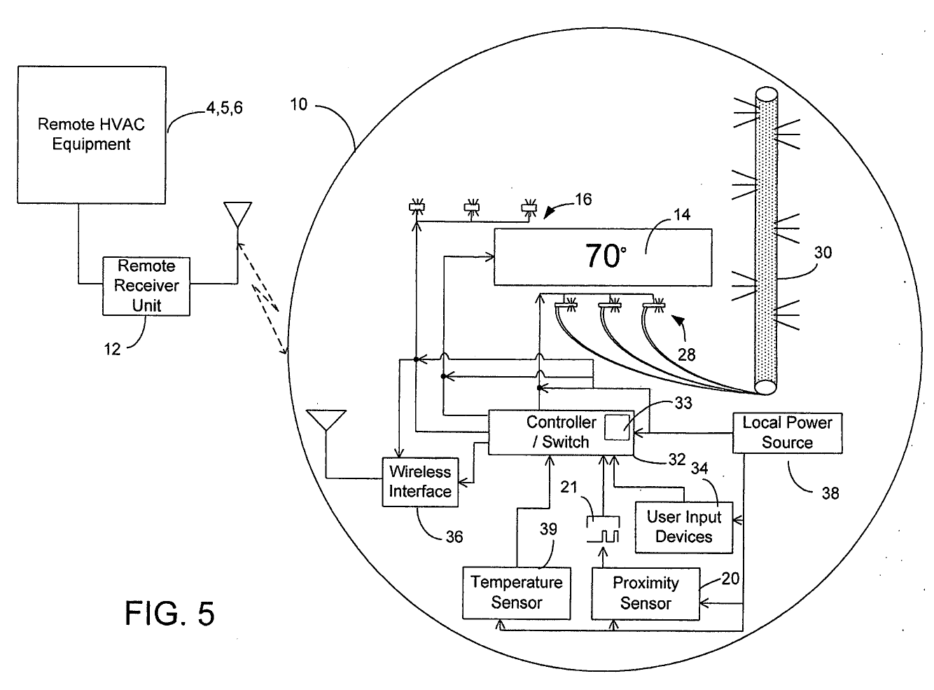

The user interface 15 further includes a plurality of user input devices 34 (FIG. 5), such as buttons 18, a heating/cooling mode slider 22, and a fan mode slider 24, wherein these user input devices 34 are used to set the operating state of the HVAC system either manually or by selecting the desired programming mode. As illustrated in FIG. 4, the displays 14, 16, and the user input buttons 18 may be disposed within the housing 26. As will be discussed in more detail in connection with FIG. 5, the user interface 15 further includes an LCD backlight 28, disposed behind the housing 26, for providing backlighting to the display 14. The user interface 15 optionally further includes a light pipe 30 (FIG. 5), connected to the LCD backlight 28, for distributing the backlighting throughout at least one part of the housing 26.

Referring to FIG. 2, the thermostat 10 further includes a proximity sensor 20 for detecting the presence of a user in the proximity of the user interface 15. In order to reduce the power consumption, the user interface 15 enters an idle state by powering down when the proximity sensor 20 indicates a lack of user proximity for a predetermined duration. In the illustrated embodiment, the user interface 15 is powered down by switching off the LCD display 14 and the status LEDs, or LED display 16. The LCD backlight 28 can also be switched off upon an indication of a lack of user proximity for a predetermined duration (FIG. 5). Alternatively, the intensity of the LCD backlight 28 (FIG. 5) is lowered when the user interface 15 is in an idle state. As shown in FIG. 3, when the proximity sensor 20 detects a user, the user interface 15 enters an active state and powers up by switching on the LCD display 14, the LED display 16, and the LCD backlight 28. Alternatively, the intensity of the LCD backlight 28 is increased when the user interface 15 is in an active state.

The sensor 20 may be a passive infrared (PIR) transducer, an ultrasonic transducer, an electromagnetic/electrostatic field transducer, a capacitive balanced field transducer, an acoustic/vibration transducer, an emissivity transducer, or any combination of these or similar devices known in the art, which can detect the presence of a potential user in the proximity of the user interface 15. Since most users view a thermostat from a typical distance of approximately 4 feet away and adjust a thermostat from even a closer distance, the sensor 20 may be chosen so as to detect user presence within this interaction envelope. Suitable examples of a PIR transducer include commercially available models, such as PIR 325 from Glolab Corporation and SSAC10-11 from Nicera. Similarly, suitable examples of an ultrasonic transducer and an acoustics transducer include, respectively, commercially available models SRF04 from Devantech and CF-2949 from Knowles Acoustics. A suitable example of a capacitive balanced field transducer includes model QT301 from Quantum Research, which could be used for detection of a user in close vicinity to the user interface 15. For longer range detection using a capacitive balanced field transducer, a person skilled in the art may use an antenna with discrete circuit components in place of a commercially available field sensor.

In the illustrated embodiment of FIGS. 2 and 3, the sensor 20 is a passive infrared transducer which may produce an output signal upon detection of infrared radiation generated by heat from a human body. While a PIR sensor is energy efficient, it is limited to detecting temperature differences between a static background object facing the sensor and a human body. Hence, when the temperature of the background object approaches that given off by a human body, a PIR sensor may become less accurate. Therefore, to increase the reliability of detection, the sensor 20 may alternatively comprise a combination of multiple sensors, such as a PIR transducer combined with an ultrasonic transducer or with any of the aforementioned sensor technologies.

The functionality of controlling the user interface 15 based on the output of the proximity sensor 20 is accomplished through the electronics connected to the user interface 15 and to the proximity sensor 20. As shown in FIG. 5, the electronics comprise a controller 32, wherein the output of the proximity sensor 20 serves as one of the inputs to controller 32. A suitable example of controller 32 is model ATMEGA 16 from Atmel. The controller 32 governs the operation of the user interface 15 through connections to the LCD display 14, the LED display 16, the LCD backlight 28, and the user input devices 34. The controller 32 is capable of operating over a range of local power source 38 output voltages, such as those produced by alkaline cell batteries, for example. To conserve energy consumption from the local power source 38, the controller 32 enters a “sleep,” or reduced energy consumption mode when a user is not detected.

In one embodiment of the invention, the controller 32 enters a reduced energy consumption mode when a potential user is not in proximity to the user interface 15. In the reduced energy consumption mode, the controller 32 switches the user interface 15 to an idle state by selectively removing power from the LCD display 14 and/or LED display 16, as well as from the LCD backlight 28. While in the reduced energy consumption mode, the controller 32 also reduces its own power consumption. This is done by activating a set of internal power saving modes within the controller 32 hardware. Such power saving modes include, for example, reducing the controller 32 clock rate, reducing the sampling frequency of the output of the temperature sensor 39, and, optionally, reducing the sampling frequency of the user input devices 34. Consequently, during the reduced energy consumption mode, the controller 32 may reduce the power required from the local power source 38 and thereby allow for a reduction of the local power source 38 output voltage.

This functionality is generally shown in a flow diagram of FIG. 5b. As can be seen in step 50, until user proximity is detected, the controller 32 is normally in a reduced energy consumption mode, which includes switching the user interface 15 to an idle state by removing power from the displays 14, 16 and the backlight 28 of the user interface 15. While in this state, however, the controller 32 in step 52 periodically samples the output of the proximity sensor 20 to determine whether a nearby user has been detected. The sampling is performed within a sensor sampling window 21 (FIG. 5) containing a predetermined number of samples. In order to reduce the amount of false positive detections, which may be caused, for example, by a passing by pet, the controller 32 may require that more than one sample falling within a sampling window 21 indicate user presence. In step 50, as long as a user is not detected within the sensor sampling window 21, the controller 32 will remain in the reduced energy consumption mode and will keep the displays 14, 16 and the backlight 28 of the user interface 15 in a powered down state. However, in step 52, if user proximity is detected within the sensor sampling window 21, the controller 32 will execute step 54 by exiting the reduced energy consumption mode, which involves switching the user interface 15 to an active state by applying power to the displays 14, 16 and the backlight 28, increasing the clock rate of the controller 32, increasing the sampling frequency of the temperature sensor 39 and of the user input devices 34, as well as increasing the output voltage of the local power source 38. After this power up step, the controller 32 will again check for detection of user proximity within the sensor sampling window 21 in step 56. If user proximity is not detected, the controller 32 will start an inactivity timer in step 58 and will keep the displays 14, 16 and the backlight 28 powered up for a predetermined duration of the inactivity timer after user proximity is no longer detected. A typical duration of the inactivity timer may be under one minute, for example. Shorter durations of the timeout period of the inactivity timer will result in additional power savings. While the inactivity timer is running, the controller 32 once again will check for user proximity in step 62. If a user is detected in step 62, the controller 32 will reset the inactivity timer in step 60 and will keep the displays 14, 16 and the backlight 28 in a powered up state by returning to step 54. If, however, user proximity is not detected, the controller 32 will check whether an inactivity timer has lapsed in step 64. If the inactivity timer has not lapsed, the controller 32 will periodically check for user proximity by looping back to step 62 for the duration of the inactivity timer or until user proximity is detected. If the inactivity timer has lapsed, without detection of user proximity, the controller 32 will power down the displays 14, 16 and the backlight 28 of the user interface 15 and reenter the reduced energy consumption mode in step 50. It should be noted that the results of periodic user detection in steps 52, 56, and 62 are stored in memory 33 (FIG.5) which, in this embodiment, is part of the controller 32. In other embodiments, however, memory 33 may be externally connected to controller 32.

In another embodiment, instead of powering down the LCD backlight 28, the above scheme may also be used by controller 32 to reduce the intensity of the LCD backlight 28 upon an indication of a lack of user proximity for the duration of the inactivity timer and increase the intensity of the LCD backlight 28 upon detection of user proximity.

Referring again to FIG. 5, the output power required from the local power source 38 is reduced when the thermostat 10 enters the reduced energy consumption mode. Such power savings are important because, in the illustrated embodiment, the thermostat 10 is a non-line powered wireless thermostat which relies on the local power source 38 for providing power for all of its functionality, including powering the user interface 15, the controller 32, and the wireless interface 36. Therefore, when the local power source 38 includes a battery housed in the thermostat 10, the battery power reserve is extended when the thermostat 10 enters the reduced energy consumption mode.

In the alternate embodiment illustrated in FIG. 5a, the thermostat 10a is a wired thermostat located where there exists AC voltage wiring 44a and control signal wiring 36a connecting the thermostat 10a to the remote HVAC equipment. In this embodiment, the AC voltage wiring 44a provides 24 VAC power from the remote HVAC equipment to the thermostat 10a in order to generate the control signals for switching the relays controlling the furnace 4, the fan 5, and the air conditioning unit 6. A separate source of power is necessary, however, to power the user interface 15, the controller 32, the temperature sensor 39, and the proximity sensor 20. Therefore, the thermostat 10a includes a local power source 38a comprising an energy storage device being charged through the AC voltage wiring 44a by a 24 VAC voltage source located in the remote HVAC equipment. The local power source 38 may be a storage capacitor, a rechargeable battery, or another energy storage device. The charge stored by the local power source 38a is similarly extended when the thermostat 10a is in the reduced energy consumption mode, as described in FIG. 5b.

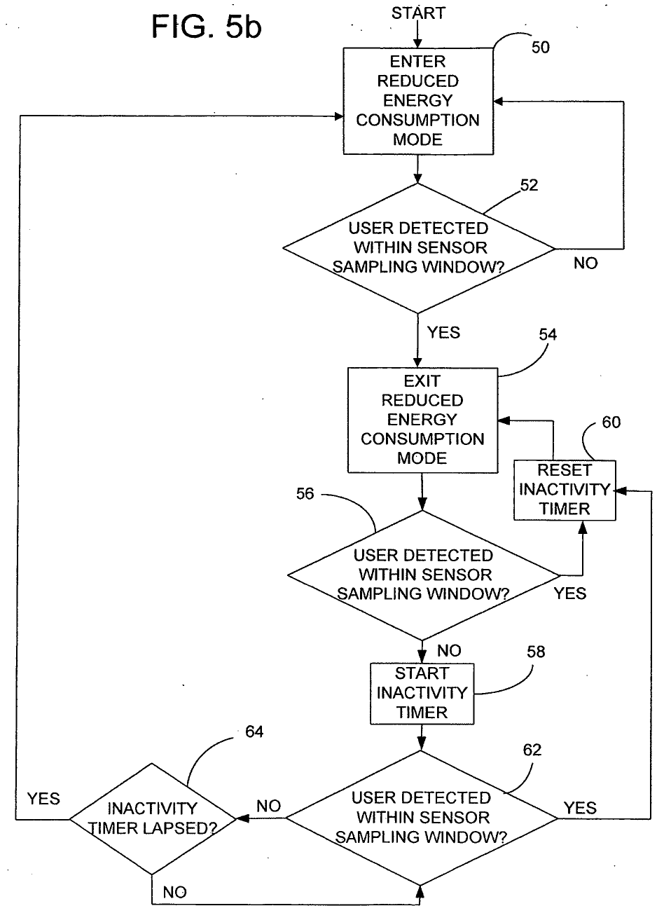

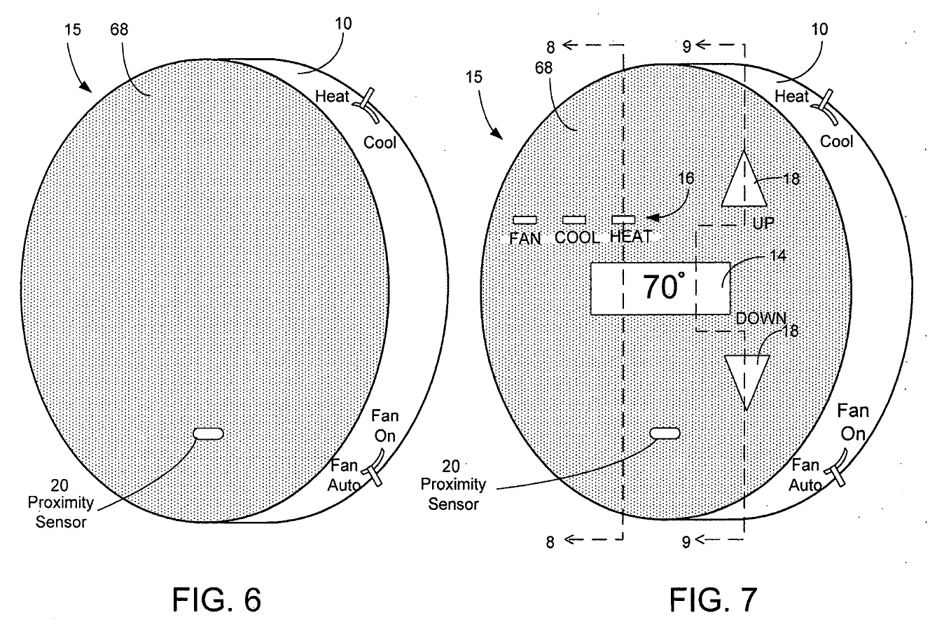

In another embodiment, illustrated in FIGS. 6-9b, the thermostat 10 further includes a housing 68 which is transparent when backlit but is opaque otherwise. In this embodiment, the housing 68 is made of a polarizing material which is semi-transparent to a particular spectrum of colors, such as the color of the LCD backlight 28, for example. In another embodiment, the housing 68 is made of clear PVC material which is coated with color that matches that of the LCD backlight 28. By way of example only, the housing 68 may also be made of Lexang, acrylic, polyacrylic, polycarbonate, or similar material which may be chemically treated, imbued with dyes, printed upon, vapor deposited, or otherwise processed to achieve the necessary coloration or polarizing characteristics.

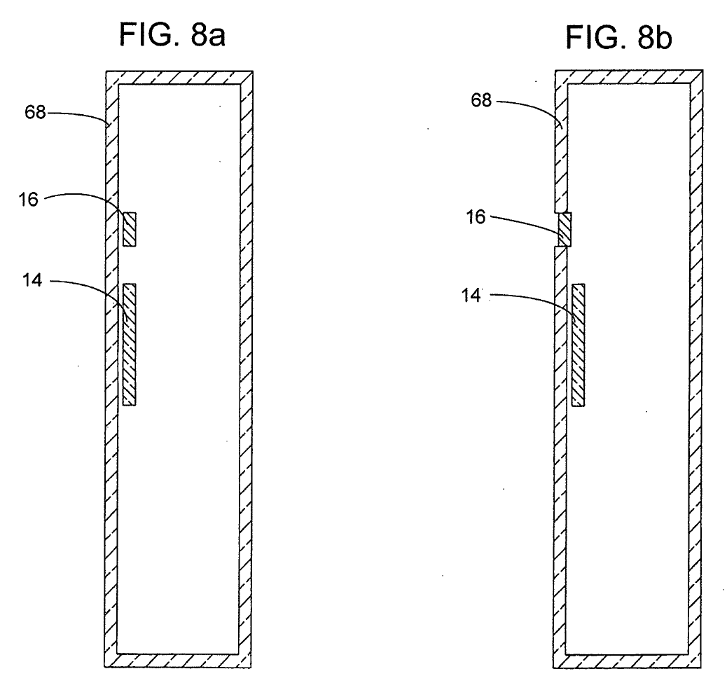

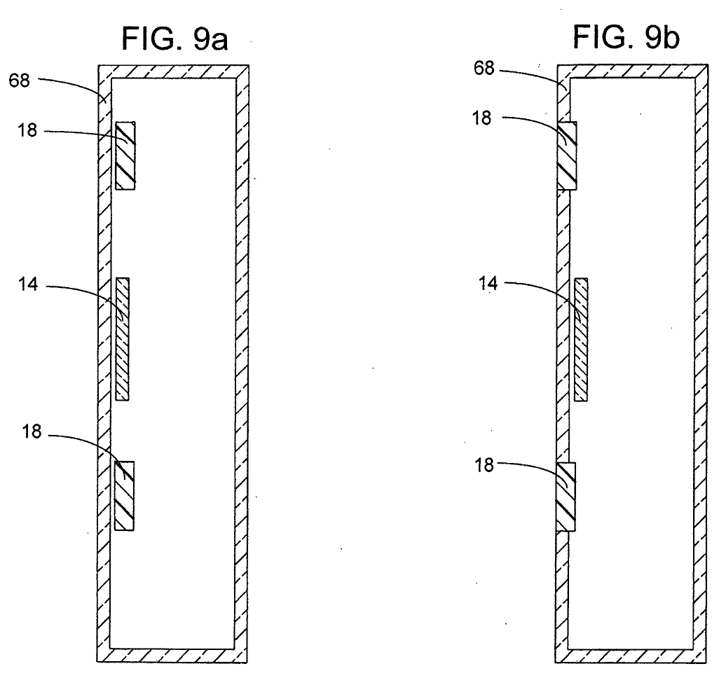

As shown in FIG. 6, while the thermostat 10 is normally in the reduced energy consumption mode, the user interface 15 is not visible to the user through the semi-transparent housing 68. Specifically, by mounting the LCD display 14 behind the housing 68, as illustrated in FIGS. 8a, 8b, the LCD display 14 is not visible when the LCD backlight 28 (FIG. 5) is powered down and does not illuminate the LCD display 14. In the embodiment shown in FIG. 8a, the LED display 16 is also mounted behind the housing 68 to provide an additional level of concealment of the user interface 15. Furthermore, as shown in FIGS. 9a, 9b, the buttons 18 are replaced by capacitive or resistive sensing elements which may be embedded within (FIG. 9b) or behind (FIG. 9a) the housing 68. Slight indentations in the surface of the housing 68 or minimal graphics or text printing on the housing 68 may be used to signify the location of the buttons 18. When the thermostat exits the reduced energy consumption mode, the LCD display 14 and the LED-display 16 of the user interface 15 are illuminated and become visible through the housing 68. The LCD display 14 becomes visible because the LCD backlight 28 is powered up. This, in turn, illuminates the semi-transparent housing 68 through the light pipe 30 (FIG. 5) and renders buttons 18 of the user interface 15 visible to the user.

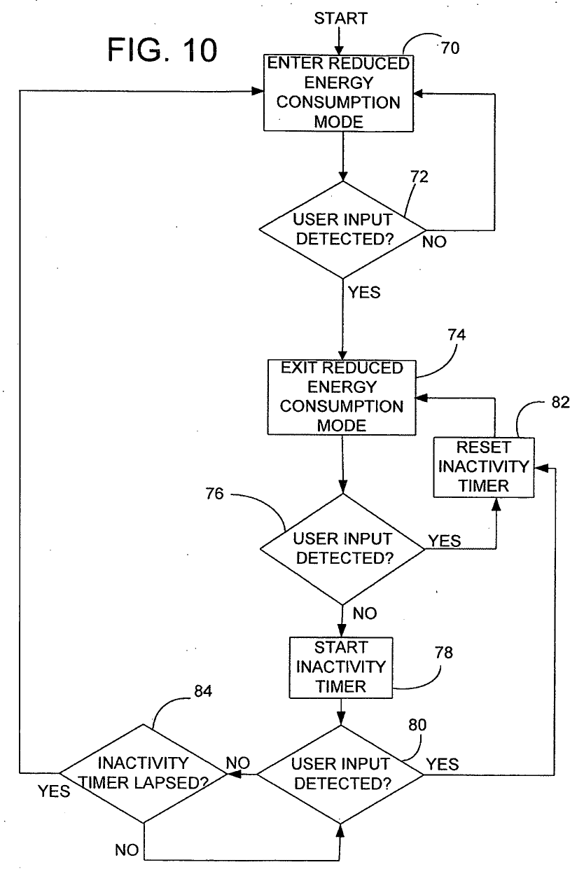

It should be noted that while the reduced energy consumption mode, as described in FIG. 5b, is invoked by sampling the output of the proximity sensor 20, other embodiments are possible wherein the thermostat 10 does not include a proximity sensor. In one such embodiment, illustrated in a flow diagram of FIG. 10, the reduced energy consumption mode is alternatively invoked by detecting user input through sampling the output of the user input devices 34. As illustrated in FIG. 10, when a user input is not detected in step 84 by sampling the output of the user input devices 34 for the duration of the inactivity timer, the controller 32 enters the reduced energy consumption mode in step 70, wherein the LCD backlight 28 is powered down, thus removing the illumination and concealing the user interface 15 behind the housing 68.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A thermostat for controlling an operating state of an HVAC system comprising:
a power consuming user interface for setting and displaying the operating state of the HVAC system;
a sensor for detecting a proximity of a user to the user interface; and
electronics connected to the user interface and to the sensor for controlling the user interface based on user proximity.

2. The thermostat of claim 1 including a battery housed in the thermostat.

3. The thermostat of claim 1, wherein the user interface is powered by an energy source remote from the thermostat.

4. The thermostat of claim 3 including an energy storage device charged by the remote energy source.

5. The thermostat of claim 4, wherein the energy storage device is one of a capacitor and a rechargeable battery.

6. The thermostat of claim 1 including a transmitter for transmitting wireless signals to a remote receiver unit.

7. The thermostat of claim 6, wherein the wireless signals are control signals.

8. The thermostat of claim 1, wherein the sensor comprises at least one of: a passive infrared transducer, an ultrasonic transducer, an electromagnetic field transducer, a capacitive balanced field transducer, an acoustic transducer, and an emissivity transducer.

9. The thermostat of claim 1, wherein the user interface is one of an LCD display, an LED display, and an LCD backlight.

10. The thermostat of claim 9, wherein the electronics include a switch for removing power from the user interface when the sensor indicates a lack of user proximity for a predetermined duration.

11. The thermostat of claim 9, wherein the electronics include a switch for applying power to the user interface when the sensor detects user proximity.

12. The thermostat of claim 9, wherein the electronics vary the intensity of the LCD backlight based on user proximity.

13. The thermostat of claim 1, wherein the electronics comprise a controller, which enters a reduced energy consumption mode when the sensor indicates a lack of user proximity for a predetermined duration and exits the reduced energy consumption mode when the sensor indicates user proximity, and
wherein, while in the reduced energy consumption mode, the controller does at least one of the following: removes power from a user interface display, removes power from a display backlight, reduces a controller clock rate, reduces a temperature sensor sampling frequency, reduces a user input device sampling frequency, and reduces a power source output voltage.

14. The thermostat of claim I including a housing that is transparent to at least one color of a backlight and the user interface including a source of light and being mounted inside the housing such that the user detection causes the source of light to illuminate the user interface, which makes the user interface visible from the exterior of the housing.

15. A method for controlling the power consuming state of a thermostat in an HVAC system, the method comprising:
normally maintaining a user interface of the thermostat in an idle state;
detecting a proximity of a user to the user interface; and
switching the user interface to an active state in response to detecting proximity of a user.

16. The method of claim 15 including maintaining the user interface in the idle state after user proximity is no longer detected.

17. The method of claim 15 including returning the user interface to the idle state after a predetermined period of time has elapsed without further detection of user proximity.

18. The method of claim 15, wherein the user interface is normally maintained in the idle state during a reduced energy consumption mode, the reduced energy consumption mode comprising at least one of the following: removing power from a user interface display, removing power from a display backlight, reducing a controller clock rate, reducing a temperature sensor sampling frequency, reducing a user input device sampling frequency, and reducing a power source output voltage.

19. A method for operating a thermostat for an HVAC system in which a user interface of the thermostat is within a housing that is transparent when backlit, the method comprising:
normally maintaining a state in which a user interface is not visible to a user;
detecting a user of the thermostat; and
illuminating the user interface, thereby rendering it visible to the user.

20. The method of claim 19 including continuing to illuminate the user interface after the user is no longer detected.

21. The method of claim 20 including removing the illumination from the user interface after a predetermined period of time has elapsed without user detection.

22. The method of claim 19 including detecting the user by detecting a person in proximity of the thermostat.

23. The method of claim 19 including detecting the user by detecting a user input.

24. The method of claim 19, wherein the user interface is normally not visible to a user during a reduced energy consumption mode, the reduced energy consumption mode comprising at least one of the following: removing power from a user interface display, removing power from a display backlight, reducing a controller clock rate, reducing a temperature sensor sampling frequency, reducing a user input device sampling frequency, and reducing a power source output voltage.
